(19) United States
(12) Patent Application Publication
(10) Pub. No.: US 2026/0257295 A1
(43) Pub. Date: Sep. 3, 2026

(54) PARTICLE-BASED FRICTION STIR ADDITIVE MANUFACTURING DEVICE AND ADDITIVE MANUFACTURING METHOD

(71) Applicant: NANJING UNIVERSITY OF AERONAUTICS AND ASTRONAUTICS, Jiangsu (CN)

(72) Inventors: Xunzhong Guo, Jiangsu (CN); Yan JIANG, Jiangsu (CN); Yizhou Shen, Jiangsu (CN); Wancheng Lyu, Jiangsu (CN)

(73) Assignee: NANJING UNIVERSITY OF AERONAUTICS AND ASTRONAUTICS, Jiangsu (CN)

(21) Appl. No.: 19/657,058

(22) Filed: Apr. 24, 2026

(30) Foreign Application Priority Data
Mar. 2, 2026 (CN) 202610245332.9

(51) Int. Cl. B23K 20/12; B22F 10/80; B22F 12/30; B22F 12/53; B33Y 10/00; B33Y 30/00; B33Y 50/00

(52) U.S. Cl. CPC B23K 20/1215; B22F 10/80; B22F 12/30; B22F 12/53; B23K 20/126; B33Y 10/00; B33Y 30/00; B33Y 50/00; B22F 2998/10

(57) ABSTRACT

A particle-based friction stir additive manufacturing device comprising a shared working platform for fixing a substrate and multiple robot units. Each robot unit includes an industrial robot, an end effector, a wire feeding mechanism, and a material feeding mechanism. The end effector comprises an electric spindle with a stirring head, a tapered disc, and a stationary shoulder having a shoulder cavity and intersecting wire and material feeding channels. The material feeding mechanism includes a pushing rod configured to cut wire into particles and deliver them into the shoulder cavity. The stirring head rotates to heat and plasticize the particles, and subsequent feeding extrudes the plasticized material to form a deposition layer on the substrate, while the stirring head mixes material into the substrate or deposited layer to form a bond.

### CROSS-REFERENCE TO RELATED APPLICATION

This application claims the priority benefit of China application serial no. 202610245332.9, filed on March 2, 2026. The entirety of the above-mentioned patent application is hereby incorporated by reference herein and made a part of this specification.

### BACKGROUND

### TECHNICAL FIELD

The additive friction stir deposition (AFSD) technology is an innovative process that applies the principle of friction stir welding to the field of solid-state additive manufacturing. By using the technology, a metal bar or wire rubs against a stirring head rotating at a high speed to generate heat, enabling the material to deposit layer by layer in a thermoplastic state below its melting point, finally forming a dense three-dimensional entity. AFSD, as a solid-phase additive manufacturing process, not only avoids the inherent problems (hot cracks, pores, element loss on ignition and segregation) in conventional welding, but also significantly improves the comprehensive mechanical properties of products, providing an innovative manufacturing solution for aluminum-based, magnesium-based alloys with high strength and poor weldability.

On the basis of the raw material form, the AFSD may be mainly classified into a bar type and a powder feeding/wire feeding type. The invention patent with Publication No. CN113172331A provides a continuous-feeding bar-based AFSD device, which achieves uninterrupted rod changing during processing. However, the structure is complex, and the bar has fixed dimensions, making it difficult to achieve real-time and flexible gradient changes in material composition. The invention patent with Publication No. CN117696924A proposes a method of pre-forming powder into bars for feeding. However, the device is more complex, and the intermediate bar-forming process introduces performance instability. More importantly, the bar AFSD generally has the problems of rough surface of the deposition layer and low geometric precision.

In order to overcome the above shortcomings, AFSD technology using wire or particles as raw materials has emerged. The technology achieves continuous and precise manufacturing of heterogeneous materials or gradient-functional materials by shearing wire into particles in real time and conveying the particles into a stationary shoulder for plasticization and forming. The technology uses wire as a raw material and has significant advantages such as convenient storage, low cost, controllable continuous feeding, and ease of real-time mixing and switching of composition, representing an important development direction of high-precision and multi-functional solid-state additive manufacturing.

However, existing AFSD technologies including the foregoing particle-based AFSD device are mostly implemented on the basis of a three-axis numerical control machine tool or a fixed dedicated machine tool. In the manufacturing of large members such as an aircraft stringer and a ship body structure, it is necessary to equip an ultra-large machine tool working platform and a gantry structure that match the dimensions of the members. This results in high equipment costs, a huge occupied area, and high operating energy consumption. Moreover, for the manufacturing of medium-sized parts, the equipment utilization rate is low, and the conflict between the manufacturing scale and the equipment cost is acute. Limited by technical principles, the existing equipment adopts a single stirring head to perform point-by-point, line-by-line, and layer-by-layer “serial” deposition regardless of the dimension of a member, resulting in a bottleneck in manufacturing efficiency. For a large-volume member, the manufacturing cycle may reach hundreds of hours, and the time cost becomes a key factor that restricts the engineering application thereof. Meanwhile, continuous single-point heat input may easily lead to excessive heat accumulation in localized areas of the member, causing significant warping deformation and difficult-to-control residual stress distribution. In addition, the three-axis machine tool can only achieve translational motion in X, Y, and Z directions, making it difficult to maintain the normal-direction posture between the tool and the substrate on complex curved surfaces or non-planar trajectories, and even more difficult to achieve the manufacturing with overhanging features. This greatly limits the application potential of the AFSD technology on complex integral members such as specially-shaped housings with stiffening ribs and internal grid structures.

### SUMMARY

Objective: In order to overcome the defects of the background art, a first objective of the present disclosure is to provide a particle-based friction stir additive manufacturing device.

A second objective is to provide an additive manufacturing method for the particle-based friction stir additive manufacturing device described above.

Technical solutions: The particle-based friction stir additive manufacturing device provided by the present disclosure includes: a shared working platform for fixing a substrate or a workpiece and a plurality of groups of robot units, where the robot units perform an additive manufacturing operation using the shared working platform as a same operation reference plane;

each robot unit includes an industrial robot, an end effector, a wire feeding mechanism, and a material feeding mechanism;

the end effector includes:

an electric spindle, where the electric spindle is fixed at a tail end of the industrial robot, and a stirring head is fixed at a driving end of the electric spindle;

a tapered disc, where one end of the tapered disc is fixed to an exterior of the electric spindle and extends in a same direction as the stirring head; and

a stationary shoulder, where the stationary shoulder is fixed to the other end of the tapered disc and is internally provided with a shoulder empty cavity corresponding to the stirring head; the stirring head passes through the shoulder empty cavity and protrudes from an outer end surface of the stationary shoulder; the stationary shoulder is provided with a wire inlet channel and a material feeding channel which extend from an outer wall to the shoulder empty cavity and are arranged intersecting with each other; and an axially outer end portion of the stationary shoulder is a forging plane;

the wire feeding mechanism conveys wire to the wire inlet channel; and

the material feeding mechanism includes a pushing rod driving device and a pushing rod arranged at a driving tail end of the pushing rod driving device; the pushing rod corresponds to the material feeding channel, and can enter the material feeding channel under the driving of the pushing rod driving device, so as to cut the wire fed into the wire inlet channel to form metal particles, and push the metal particles into a space between the shoulder empty cavity and the stirring head via the material feeding channel; the stirring head rotates to heat and plasticize the metal particles, and subsequently fed particles extrude the previously fed and plasticized metal material out of the stationary shoulder, such that a deposition layer is formed between the forging plane and the substrate, and a portion of the metal material is stirred into the substrate or the workpiece by the stirring head, forming a metallurgical bond.

Further, the industrial robot is a six-axis or above-degree-of-freedom robot.

Further, the stirring head includes, successively from a fixed distal end to a proximal end, a threaded cone member and a cylindrical member; an outer end surface of the threaded cone member is of a convex surface structure; the cylindrical member is in clearance fit with the shoulder empty cavity; and after the cylindrical member extends into the shoulder empty cavity, the material feeding channel is not blocked, such that the threaded cone member is at a position corresponding to the material feeding channel.

Further, an end portion of the stirring head extends out of the stationary shoulder by 0.5-4 mm.

Further, the wire inlet channel and the material feeding channel perpendicularly penetrate each other.

Further, an angle between the material feeding channel and the shoulder empty cavity is less than 90°, and the material feeding channel tends to incline toward the axially outer end of the stationary shoulder during feeding.

Further, a water-cooling cavity is provided inside the stationary shoulder, and coolant circulation channels are correspondingly provided.

Further, the wire feeding mechanism includes an automatic wire feeder and a flexible wire feeding pipe; the automatic wire feeder draws the wire from a damping wire disc and conveys the wire from the flexible wire feeding pipe to the wire inlet channel.

Further, the material feeding mechanism is fixed to the tapered disc through a connecting member, and the pushing rod is in clearance fit with the material feeding channel and can reciprocate in the material feeding channel.

Provided is a particle-based friction stir additive manufacturing method. The method is implemented on the basis of the particle-based friction stir additive manufacturing device as described above and includes the following steps:

S1, layering a three-dimensional model of a target member into a plurality of manufacturing subtasks and assigning the manufacturing subtasks to the plurality of groups of robot units;

S2, performing global precision calibration on each of the plurality of groups of robot units to ensure that all coordinate systems are unified, mounting and calibrating the end effector, loading specified wire, and starting the electric spindle to drive the stirring head to rotate at a certain angular velocity;

S3, starting the pushing rod driving device to drive the pushing rod to reciprocate, the pushing rod, when extending into the material feeding channel, cutting the wire and pushing cut particles into the shoulder empty cavity, and then the pushing rod retracting to an exterior of the material feeding channel; at this time, feeding a next segment of wire; and then repeating the process to achieve continuous and stable feeding until the shoulder empty cavity is filled with granular raw materials;

S4, controlling the electric spindle to ascend, a lifting distance of the electric spindle being a thickness of the deposition layer; preheating in place, at this time, the metal particles previously introduced into the stationary shoulder being gradually plasticized after rubbing against the stirring head to generate heat, and then the subsequently introduced unplasticized metal particles extruding the plasticized metal out of a bottom of the stationary shoulder, and the stirring head stirring a portion of the plasticized metal into the substrate, forming a stable metallurgical bond therebetween; and meanwhile, applying a certain forging force to the extruded material by the forging plane to assist in forming of the extruded material;

S5, simultaneously starting the end effectors of the plurality of groups of robot units, and synchronously performing particle-based friction stir deposition along a planned path starting from different partitions of the member or from symmetrical starting points; during the deposition process, the continuously fed metal particles pushing the plasticized metal inside the stationary shoulder out of a gap between the stationary shoulder and the substrate, and finally achieving stable deposition on the substrate; and

S6, after one-layer cooperative deposition is completed, the respective robots performing lifting on the basis of an instruction, taking a previous deposition layer as the substrate, and repeating the above process to perform deposition of a next deposition layer, where the deposition is performed layer by layer from a first layer in sequence from bottom to top until a last layer is deposited.

Beneficial effects: Compared with the prior art, the remarkable advantages of the present disclosure are as follows: By means of the multi-robot spatial parallel operation, the deposition time of large members is changed from “linear accumulation” to “parallel reduction”, the manufacturing efficiency is improved, and the time cost is greatly reduced. With the high degree of freedom of the robot, the end effector may maintain an optimal deposition posture at any position in space, and can manufacture any complex geometric shape including complex curved surfaces, inner cavity structures, and large-angle overhanging features, thereby completely releasing the degree of freedom of design. Multiple heat sources work in parallel or symmetrically, which effectively balances the overall thermocycling and greatly reduces the residual stress and warping deformation of the member. Using a particle-based friction stir additive manufacturing device to form a member allows for the real-time switching of wire types to manufacture gradient materials or composite materials, thereby enabling the integrated additive manufacturing of parts made of heterogeneous materials, reducing the total weight of the parts, and reducing the processing time.

### BRIEF DESCRIPTION OF THE DRAWINGS

FIG. 1 is a schematic diagram of an overall structure according to the present disclosure.

FIG. 2 is a schematic structural diagram of an end effector according to the present disclosure.

FIG. 3 is a schematic structural diagram of a stirring head and a pushing rod according to the present disclosure.

FIG. 4 is a schematic structural diagram of a stationary shoulder according to the present disclosure.

### DESCRIPTION OF THE EMBODIMENTS

The technical solutions of the present disclosure will be further described below with reference to the drawings and examples.

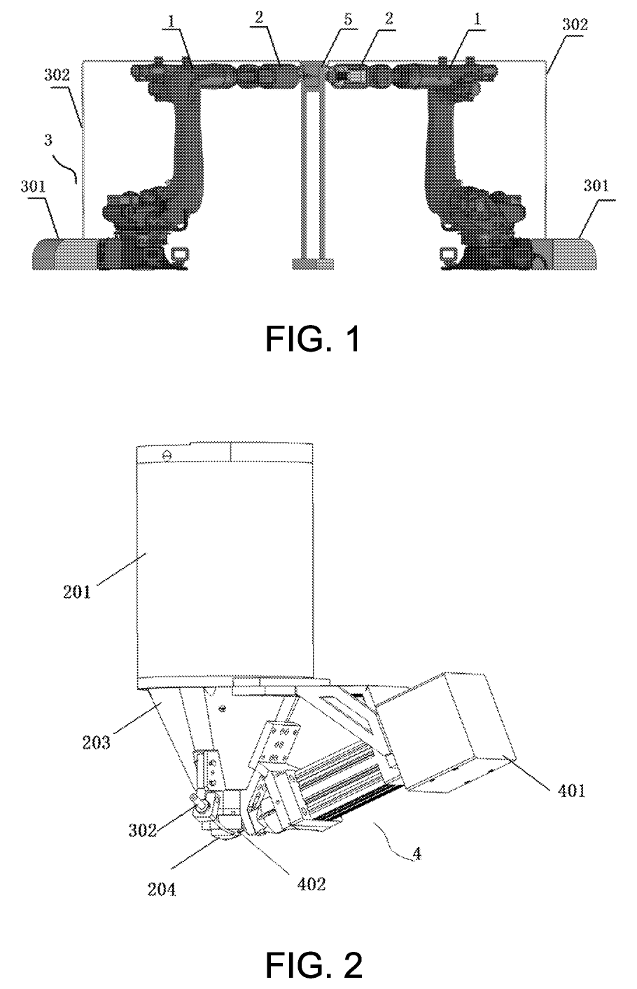

Provided is a particle-based friction stir additive manufacturing device as shown in FIG. 1, which includes: a shared working platform 5 for fixing a substrate or a workpiece, and a plurality of groups of robot units. The robot units perform an additive manufacturing operation with the shared working platform 5 as a same operation reference plane. Each group of robot units constitutes an independent and complete additive manufacturing module, and the respective robot units are independent in physical space and logically achieve precise synchronization and cooperation.

Each robot unit includes an industrial robot 1, an end effector 2, a wire feeding mechanism 3, and a material feeding mechanism 4. The industrial robot 1 is a six-axis or above-degree-of-freedom robot, and may be a KR 300 R2700_2 C_F high-load industrial robot from KUKA.

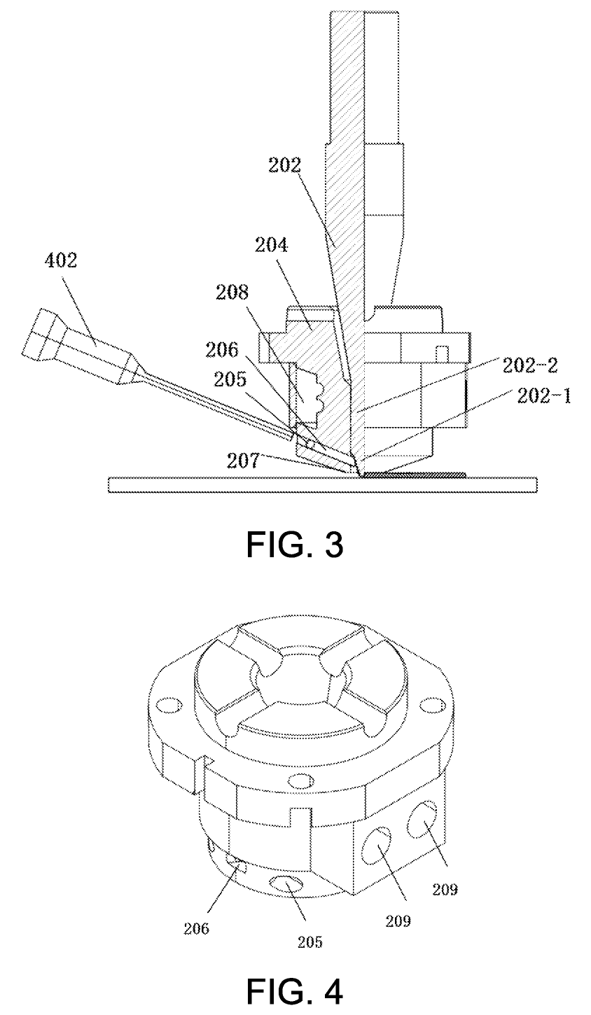

As shown in FIG. 2 to FIG. 4, the end effector 2 includes: an electric spindle 201, a tapered disc 203, and a stationary shoulder 204.

The electric spindle 201 is fixed at the tail end of the industrial robot 1, and a stirring head 202 is fixed at a driving end of the electric spindle 201; one end of the tapered disc 203 is fixed to the exterior of the electric spindle 201 and extends in the same direction as the stirring head 202; provided is the stationary shoulder 204, the stationary shoulder 204 is fixed to the other end of the tapered disc 203 and is internally provided with a shoulder empty cavity corresponding to the stirring head 202; the stirring head 202 passes through the shoulder empty cavity and protrudes from an outer end surface of the stationary shoulder 204; the stationary shoulder 204 is provided with a wire inlet channel 205 and a material feeding channel 206 which extend from an outer wall to the shoulder empty cavity and are arranged intersecting with each other; and an axially outer end portion of the stationary shoulder 204 is a forging plane 207.

The stirring head 202 includes, successively from a fixed distal end to a proximal end, a threaded cone member 202-1 and a cylindrical member 202-2; an outer end surface of the threaded cone member 202-1 is of a convex surface structure; the cylindrical member 202-2 is in clearance fit with the shoulder empty cavity; and after the cylindrical member 202-2 extends into the shoulder empty cavity, the material feeding channel 206 is not blocked, such that the threaded cone member 202-1 is at a position corresponding to the material feeding channel 206. The threaded cone member 202-1 has a cone angle of 20-50°, a total length of about 6.7 mm and a width of about 7 mm, a thread depth of 0.4 mm, and a pitch of 0.1 mm. The length and the taper may be adjusted on the basis of actual working conditions. After mounting, an end portion of the stirring head 202 extends out of the stationary shoulder by 0.5-4 mm. The wire inlet channel 205 and the material feeding channel 206 perpendicularly penetrate each other to facilitate the cutting of wire by the pushing rod. The wire types include aluminum alloy, magnesium alloy, or copper alloy, with a diameter of 0.4 mm to 2.5 mm. Wire made of different materials may be used to achieve integrated additive manufacturing of heterogeneous materials. An angle between the material feeding channel 206 and the shoulder empty cavity is less than 90°, and the material feeding channel tends to incline toward the axially outer end of the stationary shoulder 204 during feeding. A water-cooling cavity 208 is provided inside the stationary shoulder 204, and coolant circulation channels 209 are correspondingly provided.

The wire feeding mechanism 3 conveys the wire to the wire inlet channel 205. The wire feeding mechanism 3 includes an automatic wire feeder 301 and a flexible wire feeding pipe 302. The automatic wire feeder 301 draws the wire from a damping wire disc and conveys the wire from the flexible wire feeding pipe 302 to the wire inlet channel 205.

The material feeding mechanism 4 includes a pushing rod driving device 401 and a pushing rod 402 arranged at a driving tail end of the pushing rod. The material feeding mechanism 4 is fixed to the tapered disc 203 through a connecting member, and the pushing rod 402 is in clearance fit with the material feeding channel 206 and can reciprocate in the material feeding channel 206. The pushing rod 402 corresponds to the material feeding channel 206, and can enter the material feeding channel 206 under the driving of the pushing rod driving device 401, so as to cut the wire fed into the wire inlet channel 205 to form metal particles, and push the metal particles into a space between the shoulder empty cavity and the stirring head 202 via the material feed channel 206; the stirring head 202 rotates to heat and plasticize the metal particles, and subsequently fed particles extrude the previously fed and plasticized metal material out of the stationary shoulder 204, such that a deposition layer is formed between the bottom of the forging plane 207 and the substrate, and a portion of the metal material is stirred into the substrate or the workpiece by the stirring head 202, forming a metallurgical bond.

Provided is an additive manufacturing method using the particle-based friction stir additive manufacturing device as described above. The method includes the following steps:

S1, layering a three-dimensional model of a target member into a plurality of manufacturing subtasks and assigning the manufacturing subtasks to the plurality of groups of robot units;

S2, performing global precision calibration on each of the plurality of groups of robot units to ensure that all coordinate systems are unified, mounting and calibrating the end effector, loading specified wire, and starting the electric spindle to drive the stirring head to rotate at a certain angular velocity;

S3, starting the pushing rod driving device to drive the pushing rod to reciprocate, the pushing rod, when extending into the material feeding channel, cutting the wire and pushing cut particles into the shoulder empty cavity, and then the pushing rod retracting to an exterior of the material feeding channel; at this time, feeding a next segment of wire; and then repeating the process to achieve continuous and stable feeding until the shoulder empty cavity is filled with granular raw materials;

S4, controlling the electric spindle to ascend, a lifting distance of the electric spindle being a thickness of the deposition layer; preheating in place, at this time, the metal particles previously introduced into the stationary shoulder being gradually plasticized after rubbing against the stirring head to generate heat, and then the subsequently introduced unplasticized metal particles extruding the plasticized metal out of a bottom of the stationary shoulder, and the stirring head stirring a portion of the plasticized metal into the substrate, forming a stable metallurgical bond therebetween; and meanwhile, applying a certain forging force to the extruded material by the forging plane to assist in forming of the extruded material;

S5, simultaneously starting the end effectors of the plurality of groups of robot units, and synchronously performing particle-based friction stir deposition along a planned path starting from different partitions of the member or from symmetrical starting points; during the deposition process, the continuously fed metal particles pushing the plasticized metal inside the stationary shoulder out of a gap between the stationary shoulder and the substrate, and finally achieving stable deposition on the substrate; and

S6, after one-layer cooperative deposition is completed, the respective robots performing lifting on the basis of an instruction, taking a previous deposition layer as the substrate, and repeating the above process to perform deposition of a next deposition layer, where the deposition is performed layer by layer from a first layer in sequence from bottom to top until a last layer is deposited.

One robot may also be used as a main unit to perform material deposition, and the other one or more robots may be used as auxiliary units to perform cooperative operations such as follow-up thermal insulation, local rolling compaction, or auxiliary cooling.

Taking the manufacturing of aluminum-copper bi-alloy AFSD parts as an example:

7075 aluminum alloy wire and H62 brass wire, both with a diameter of 1.6 mm, are used for bidirectional additive manufacturing of a cylindrical member. The member has an inner diameter of 400 mm and a height of 20 mm. The lower 10 mm is made of aluminum, and the upper 10 mm is made of copper. The substrate with a cleaned surface is fixed on the shared working platform 5. The 7075 aluminum alloy wire is fed into the wire inlet channel 205 of the end effector 2 of the industrial robot on the left side. The rotation speed of the stirring head 202 is set to 450 rpm, the feeding speed is set to 45 mm/min, and the wire feeding frequency of the pushing rod 402 is set to 1 time/second. The H62 brass wire is fed into the wire inlet channel 205 of the axial shoulder of the end effector 2 of the industrial robot on the right side. The rotation speed of the stirring head 202 is set to 300 rpm, the feeding speed is set to 55 mm/min, and the wire feeding frequency of the pushing rod 402 is set to 1.5 times/second. The end effectors of the robots on both sides are started at the same time, and the particle-based friction stir deposition is carried out synchronously along the planned path starting from the symmetrical starting points of the member. Each industrial robot 1 is started, the electric spindle 201 is controlled to descend to the forging plane 207 of the stationary shoulder 204 to be attached to the substrate, the pushing rod driving device 401 is started, and the pushing rod 402 starts to cut off and feed the metal material. Because the gap between the stationary shoulder 204 and the stirring head 202 needs a certain time to be filled up, this process pauses for 5 seconds. During the waiting process, the metal particles are pressed against each other and rub against the stirring head to generate heat, and then gradually transition to a thermoplastic state. After 5 seconds, the electric spindle ascends, with an ascending speed of 0.5 mm/s and an ascending distance of 2 mm. During the ascending process, the thermoplastic metal raw material is continuously extruded, and continuously combines with the previous material under the stirring and shearing action of the stirring head 202 to form an initial deposition layer. After the electric spindle ascends and the metal particles are preheated in place for 5 seconds, the thermoplastic raw material continuously overflows during this period and is then constrained by the forging plane 207, and the overflowing raw material and the forging plane 207 jointly exert a certain forging force on the initial deposition layer, such that the initial deposition layer is firmly bonded with the substrate. After the preheating is completed, the robot starts to travel on the basis of the planned path and the given speed, and the circulating water cooling is synchronously activated to cool the equipment. During processing, the subsequently fed unplasticized metal particles continuously and uniformly extrude the completely plasticized metal raw material inside the axial shoulder into the gap between the stationary shoulder and the substrate, forming a subsequent deposition layer. After completing one full cycle, the robot ascends immediately without waiting, with the ascending speed and distance unchanged. Thereafter, the previous steps are repeated.

What is claimed is:

1. A particle-based friction stir additive manufacturing device, comprising: a shared working platform for fixing a substrate or a workpiece, and a plurality of groups of robot units, wherein the robot units perform an additive manufacturing operation using the shared working platform as a same operation reference plane;
each robot unit comprises an industrial robot, an end effector, a wire feeding mechanism, and a material feeding mechanism;
the end effector comprises:
an electric spindle, wherein the electric spindle is fixed at a tail end of the industrial robot, and a stirring head is fixed at a driving end of the electric spindle;
a tapered disc, wherein one end of the tapered disc is fixed to an exterior of the electric spindle and extends in a same direction as the stirring head; and
a stationary shoulder, wherein the stationary shoulder is fixed to the other end of the tapered disc and is internally provided with a shoulder empty cavity corresponding to the stirring head; the stirring head passes through the shoulder empty cavity and protrudes from an outer end surface of the stationary shoulder; the stationary shoulder is provided with a wire inlet channel and a material feeding channel which extend from an outer wall to the shoulder empty cavity and are arranged intersecting with each other; and an axially outer end portion of the stationary shoulder is a forging plane;
the wire feeding mechanism conveys wire to the wire inlet channel; and
the material feeding mechanism comprises a pushing rod driving device and a pushing rod arranged at a driving tail end of the pushing rod driving device; the pushing rod corresponds to the material feeding channel, and can enter the material feeding channel under the driving of the pushing rod driving device, so as to cut the wire fed into the wire inlet channel to form metal particles, and push the metal particles into a space between the shoulder empty cavity and the stirring head via the material feeding channel; the stirring head rotates to heat and plasticize the metal particles, and subsequently fed particles extrude the previously fed and plasticized metal material out of the stationary shoulder, such that a deposition layer is formed between the forging plane and the substrate, and a portion of the metal material is stirred into the substrate or the already deposited layer by the stirring head, forming a metallurgical bond.

2. The particle-based friction stir additive manufacturing device according to claim 1, wherein the industrial robot is a six-axis or above-degree-of-freedom robot.

3. The particle-based friction stir additive manufacturing device according to claim 1, wherein the stirring head comprises, successively from a fixed distal end to a proximal end, a threaded cone member and a cylindrical member; an outer end surface of the threaded cone member is of a convex surface structure; the cylindrical member is in clearance fit with the shoulder empty cavity; and after the cylindrical member extends into the shoulder empty cavity, the material feeding channel is not blocked, such that the threaded cone member is at a position corresponding to the material feeding channel.

4. The particle-based friction stir additive manufacturing device according to claim 1, wherein an end portion of the stirring head extends out of the stationary shoulder by 0.5-4 mm.

5. The particle-based friction stir additive manufacturing device according to claim 1, wherein the wire inlet channel and the material feeding channel perpendicularly penetrate each other.

6. The particle-based friction stir additive manufacturing device according to claim 1, wherein an angle between the material feeding channel and the shoulder empty cavity is less than 90°, and the material feeding channel tends to incline toward the axially outer end of the stationary shoulder during feeding.

7. The particle-based friction stir additive manufacturing device according to claim 1, wherein a water-cooling cavity is provided inside the stationary shoulder, and coolant circulation channels are correspondingly provided.

8. The particle-based friction stir additive manufacturing device according to claim 1, wherein the wire feeding mechanism comprises an automatic wire feeder and a flexible wire feeding pipe; the automatic wire feeder draws the wire from a damping wire disc and conveys the wire from the flexible wire feeding pipe to the wire inlet channel.

9. The particle-based friction stir additive manufacturing device according to claim 1, wherein the material feeding mechanism is fixed to the tapered disc through a connecting member, and the pushing rod is in clearance fit with the material feeding channel and can reciprocate in the material feeding channel.

10. A particle-based friction stir additive manufacturing method, wherein the method is implemented on the basis of the particle-based friction stir additive manufacturing device according to claim 1 and comprises the following steps:
S1, layering a three-dimensional model of a target member into a plurality of manufacturing subtasks and assigning the manufacturing subtasks to the plurality of groups of robot units;
S2, performing global precision calibration on each of the plurality of groups of robot units to ensure that all coordinate systems are unified, mounting and calibrating the end effector, loading specified wire, and starting the electric spindle to drive the stirring head to rotate at a certain angular velocity;
S3, starting the pushing rod driving device to drive the pushing rod to reciprocate, the pushing rod, when extending into the material feeding channel, cutting the wire and pushing cut particles into the shoulder empty cavity, and then the pushing rod retracting to an exterior of the material feeding channel; at this time, feeding a next segment of wire; and then repeating the process to achieve continuous and stable feeding until the shoulder empty cavity is filled with granular raw materials;
S4, controlling the electric spindle to ascend, a lifting distance of the electric spindle being a thickness of the deposition layer; preheating in place, at this time, the metal particles previously introduced into the stationary shoulder being gradually plasticized after rubbing against the stirring head to generate heat, and then the subsequently introduced unplasticized metal particles extruding the plasticized metal out of a bottom of the stationary shoulder, and the stirring head stirring a portion of the plasticized metal into the substrate, forming a stable metallurgical bond therebetween; and meanwhile, applying a certain forging force to the extruded material by the forging plane to assist in forming of the extruded material;
S5, simultaneously starting the end effectors of the plurality of groups of robot units, and synchronously performing particle-based friction stir deposition along a planned path starting from different partitions of the member or from symmetrical starting points; during the deposition process, the continuously fed metal particles pushing the plasticized metal inside the stationary shoulder out of a gap between the stationary shoulder and the substrate, and finally achieving stable deposition on the substrate; and
S6, after one-layer cooperative deposition is completed, the respective robots performing lifting on the basis of an instruction, taking a previous deposition layer as the substrate, and repeating the above process to perform deposition of a next deposition layer, wherein the deposition is performed layer by layer from a first layer in sequence from bottom to top until a last layer is deposited.
